(19) United States
(12) Patent Application Publication
(10) Pub. No.: US 2016/0075448 A1
(43) Pub. Date: Mar. 17, 2016

(54) Apparatus for the management of an airship's two types of cables

(71) Applicant: Nathanial Henry Lewis, Fallon, NV (US)

(72) Inventor: Nathanial Henry Lewis, Fallon, NV (US)

(21) Appl. No.: 14/121,514

(22) Filed: Sep. 15, 2014

(51) Int. Cl. B64F 1/14

(52) U.S. Cl. CPC B64F 1/14

(57) ABSTRACT

This apparatus automatically brings a physical control cable and an utility control cable together during the launching. It will separate the physical control cable from the utility control cable during mooring. The physical control cable is connected to an electric winch which is powered and controlled through an electric cable, the utility control cable is free to move around. The above apparatus can be operated by one person at a control panel with video screens inside a housing.

### BACKGROUND OF THE PRIOR ART

The following U.S. Pat. Nos. 1,061,484; 5,115,997; 7,287,723B2, and 8,083,174B2 all were about tethered airships. They describe no apparatus for mooring and launching like this one. The only description from all was basically about a single tethered cable. The cable is normally made from Kevlar and carries both the power supply to an airship and fiber optics for communications. However, there will come a time when a winch powered physical control cable is best for the up and down movements of a tethered airship. One example would be in very strong winds. The stress and strain forces on this physical control cable should not be placed on a utility control cable.

### BRIEF SUMMARY OF THE INVENTION

There are a few places where a one-man operation is highly desirable. A large Coast Guard cutter that can patrol day and night, in all weather and in rough seas is a specific example; there are others. The launching and mooring of a tethered airship can be done by one person, no more than two. The airship has to be well supported by a strong, physical control cable. The cable should be able to take the stress and strain forces of an electric winch acting on it. Which is controlled by an operator sitting at a control panel with video screens inside a housing.

This apparatus will automatically bring the two types of cables together during the launching (up). It will separate the physical control cable from any utility control cable or cables during mooring (down). A physical control cable can be made from steel or Kevlar; steel is preferred. A utility cable can be one with fiber optics for communication.

### BRIEF DESCRIPTION OF THE DRAWINGS

FIG. 1 is a side view of a tethered airship connected to its housing mounted on a vehicle.

FIG. 2 is a top view of an apparatus for launching and mooring the airship mounted inside a housing, control cables omitted for clarity.

FIG. 3 is a side view of the apparatus mounted to the floor of the housing.

FIG. 4 is a sectional view of the main structure of the apparatus only, cables have been added in this view.

FIG. 5 is a top view of the top portion of the main structure.

### DETAILED DESCRIPTION

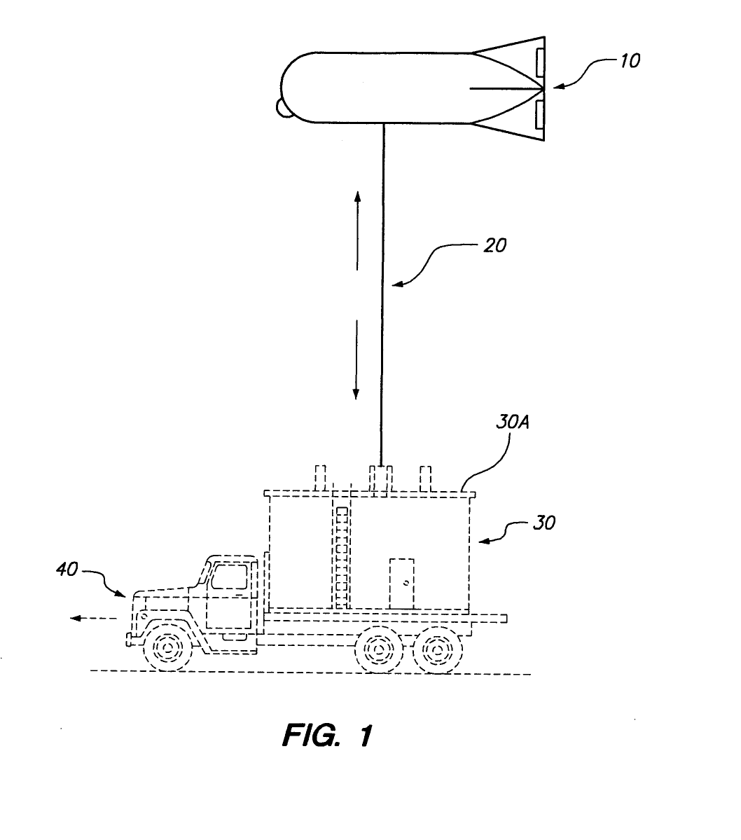

Refer to FIG. 1. A tethered airship 10 is connected to a control panel inside a housing 30, by a line 20 of control cables through a hole in the roof 30A of the housing 30. The housing 30 is mounted on a flatbed truck 40. Any vehicle or platform can be used.

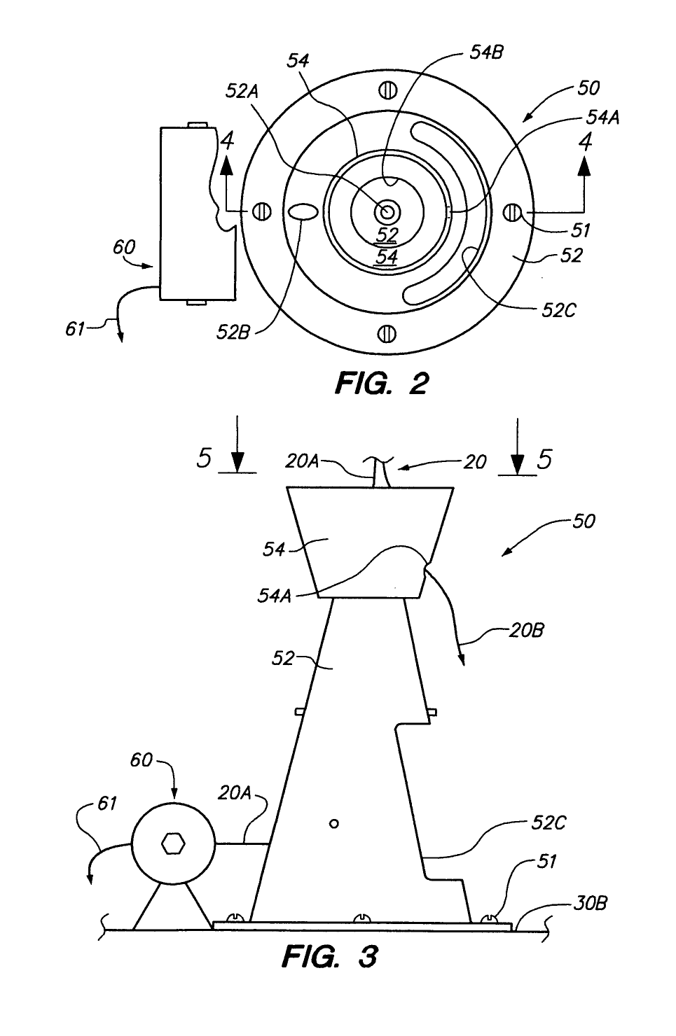

Refer to FIG. 2. The apparatus' main structure 50 comprises an upper structure 54 placed over a lower structure 52 that is hollowed with a relatively small hole 52A at its top. The structure 52 has fastening means 51, a cut-out 52C and a small hole 52B in its side near its bottom. The upper structure 54 has a small hole 54A in its side and a substantially larger hole 54B in its bottom for receiving the upper part of the lower structure 52. An electric winch 60 is shown with its power cable 61. The line 20 of control cables has been omitted for clarity.

Refer to FIG. 3. The vertical apparatus' main structure 50 comprises the bucket shaped structure 54 with a hole 54A in its side, and the cone shaped structure 52 is fastened to the floor 30B of the housing 30 by screws 51 through its base plate. The cut-out 52C is for inner maintenance purposes. A line 20 of control cables 20A and 20B is the medium for physical, electrical, grounding, surveillance, communication and controlling connections between the airship 10 and the control panel and housing 30.

The physical control cable 20A is connected to the electric winch 60, which is powered and controlled through its electric cable 61. This control cable 20A should be made from steel, which has the properties of tensile strength, flexible and tough. The utility control cable 20B or cables can be made from many types of materials, one being Kevlar.

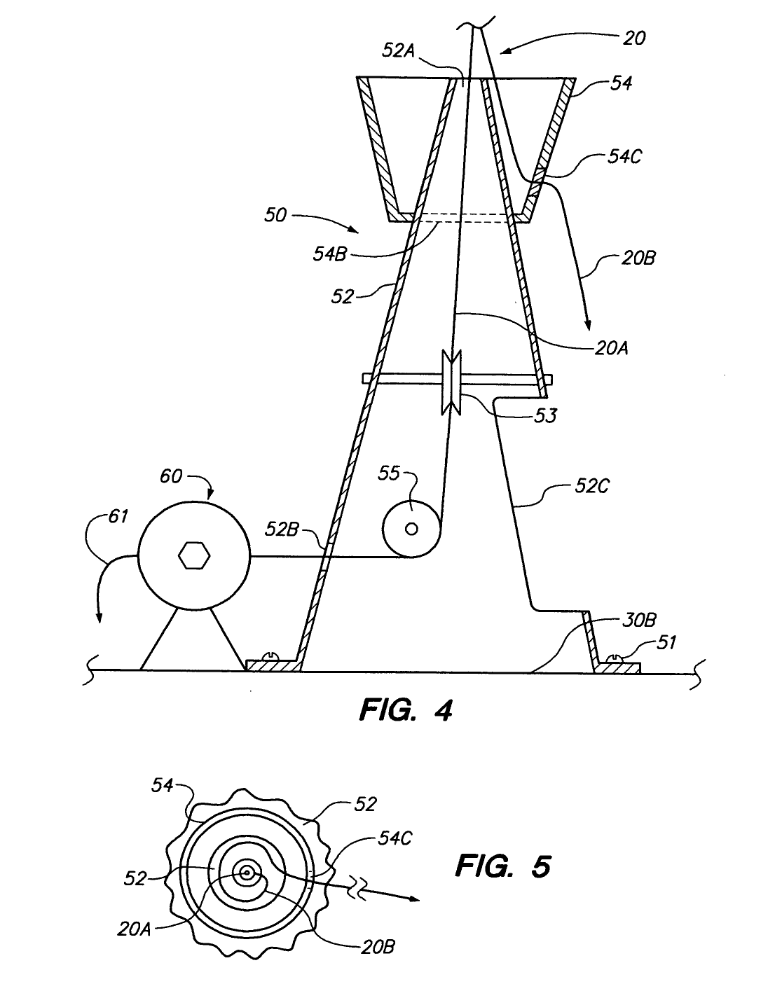

Refer to FIG. 4. The bucket shaped structure 54 has a plug 54C in the hole 54A (see FIGS. 2 and 3), it 54C should be designed to hold the utility control cable 20B or cables in place. An upper pulley 53 and a lower pulley 55 are mounted inside the cone shaped structure 52; it is mounted to the floor 30B by screws, one of many fastening means 51. The lower pulley 55 directs the lightweight and strong cable 20A to the winch 60 on the floor 30B. The following part 61 and holes 54B, 52A, 52B and 52C are shown here and described above.

Ref to FIG. 5. The bucket shaped structure 54 is shown placed over the cone shaped structure 52. The utility control cable 20B or cables are held in a fixed position by the plug 54C in the hole 54A (see FIGS. 2 and 3). Thereby, the upper part of the cable 20B or cables can more or less coil around the upper part of the cone shaped structure 52 and come to rest in the bucket shaped structure 54. The bucket shaped structure 54 can be used to catch unwanted rain water coming through the cables' hole in the roof 30A.

No new technology is needed for this apparatus. Many parts can be made by relatively minor fabrication of off-the-shelf hardware parts. The apparatus can be designed to handle the winch powered physical control cable 20A only, when a utility control cable 20B isn't necessary.

I claim:

1-3. (canceled)

4. An apparatus that will bring together a physical control cable and an utility control cable during the launching, and separate them during the mooring of a tethered airship and said apparatus comprises:
a) an upper structure with a bucket shape, said bucket shaped structure has a small hole in its side and a larger hole in its bottom;
b) a lower structure with a cone shape, said cone shaped structure is hollowed inside, it has a small hole at its top and a small hole in its side near its bottom, and it has a base plate at its bottom for fastening means, an upper pulley and a lower pulley are mounted inside said hollowed cone shaped structure;
c) a vertical main structure comprises said upper bucket shaped structure and through its said larger hole in its bottom, is the top of said lower hollow cone shaped structure, said cone shaped structure has said small hole at its top and said small hole in its side near its bottom, and
d) whereby said small hole at its top and said small hole in its side near its bottom both of said lower hollow cone shaped structure, allows the passing of said physical control cable between an electric winch and said tethered airship.

5. The said apparatus as claimed in claim 4, wherein said upper bucket shaped structure with its small hole in its side farther comprising a plug; whereby said plug can hold said utility cable in a fixed position in said hole and it comes to rest in said bucket shaped structure.

6. The said apparatus as claimed in claim 4, wherein said fastening means being screws; whereby said apparatus is fastened to the floor of a housing.
